(19) United States
(12) Patent Application Publication
(10) Pub. No.: US 2007/0076709 A1
(43) Pub. Date: Apr. 5, 2007

(54) Apparatus and method for facilitating a virtual private local area network service with realm specific addresses

(76) Inventors: Geoffrey Mattson, San Jose, CA (US); Philip Yim, Petaluma, CA (US); Eu-Jin Lim, San Jose, CA (US)

Correspondence Address: COOLEY GODWARD KRONISH LLP, 3000 EL CAMINO REAL, 5 PALO ALTO SQUARE, PALO ALTO, CA, 94306, US

(21) Appl. No.: 11/479,122

(22) Filed: Jun. 30, 2006

Related U.S. Application Data
(60) Provisional application No. 60/695,970, filed on Jul. 1, 2005.

(51) Int. Cl. H04L 12/56

(52) U.S. Cl. 370/389

(57) ABSTRACT

A method of processing traffic in a Virtual Private LAN service includes replacing a MAC address from a packet with a realm specific Virtual Private Network address. The packet with the realm specific Virtual Private Network address is then processed.

### CROSS REFERENCE TO RELATED APPLICATIONS

This application claims the benefit of U.S. Provisional Patent Application No. 60/695,970, filed Jul. 1, 2005, entitled,“ Apparatus and Method for Facilitating a Virtual Private Local Area Network Service with Realm Specific Addresses,” the contents of which are incorporated herein by reference.

### BRIEF DESCRIPTION OF THE INVENTION

This invention relates generally to network communications. More particularly, this invention relates to facilitating a virtual private local area network service with realm specific addresses that eliminate MAC address scaling problems.

### BACKGROUND OF THE INVENTION

Multi Protocol Label Switching (MPLS) supports various types of Virtual Private Networks (VPNs). One type of VPN is a Layer 3 multipoint VPN or Internet Protocol (IP) VPN, which is sometimes referred to as a Virtual Private Routed Network (VPRN). Another type of VPN is a Layer 2 point-to-point VPN, which is a collection of separate Virtual Leased Lines (VLL) or Pseudo Wires (PW). Still another type of VPN is the Layer 2 multipoint VPN, which is also referred to as a Virtual Private LAN Service (VPLS). The present invention is directed toward improving VPLS architectures.

VPLS, also known as Transparent LAN Service (TLS) or E-LAN service, is a Layer 2 multipoint VPN that allows multiple sites to be connected in a single bridged domain over a provider managed IP/MPLS network. All customer sites in a VPLS instance (i.e., a VPLS for a particular enterprise) appear to be on the same LAN, regardless of location. VPLS uses an Ethernet interface with the customer, simplifying the LAN/WAN boundary and allowing rapid and flexible service provisioning.

As shown in FIG. 1, a VPLS 100 comprises Customer Edges (CE) 102_1 through 102_9, Provider Edges (PE) 104_1 through 104_3, and a core MPLS network 106. A customer edge 102 is a router or switch located at the premises of a network service customer. The customer edge 102 can be owned and managed by the customer or owned and managed by the service provider. The customer edge 102 is connected to a provider edge 104 via an attachment circuit 108. In the case of VPLS, Ethernet is the interface between the CE 102 and the PE 104.

The VPLS originates and terminates at the PEs. The PEs contain the VPN intelligence. The PEs set up and connect tunnels to other PEs. Since VPLS is an Ethernet Layer 2 service, the PE is configured for Media Access Control (MAC) learning, bridging and replication on a per-VPLS basis.

The IP/MPLS core network 106 interconnects the PEs. It does not participate in the VPN functionality other than to switch traffic based on MPLS labels. The Label Distribution Protocol (LDP), the Resource Reservation Protocol—Traffic Engineering (RSVP-TE) or a combination of LDP and RSVP-TE can be used to set up tunnels. A mesh of inner tunnels 110, sometimes called pseudo wires, is created between all the PEs of a VPLS. An auto-discovery mechanism locates all the PEs participating in a VPLS.

The PEs 104 support Ethernet features, like MAC learning, packet replication and forwarding. They learn the source MAC addresses or the traffic arriving on their access and network ports. This means that the PEs must implement a bridge for reach VPLS instance. This bridge is sometimes referred to as a Virtual Bridge (VB). The network 100 of FIG. 1 may support many VPLS instances with many VBs. The VB functionality is implemented through a Forwarding Information Base (FIB) for each VPLS. The FIB is populated with all the learned MAC addresses and therefore is sometimes referred to as a MAC address table. All traffic is switched based on MAC addresses and forwarded between all participating PE routers using LSP tunnels. Unknown packets (e.g., a packet with a MAC address that has not been learned) are replicated and forwarded on all LSPs to the PEs participating in the service until the target station responds and the MAC address is learned by the PE routers associated with the service.

Pseudo Wires (PW) are created with a pair of unidirectional LSPs or virtual connections. For VC-label signaling between PEs, each PE initiates a targeted LDP session to the peer PE and communicates to the peer PE what VC label to use when sending packets for the VPLS instance. The specific VPLS instance is identified in the signaling exchange using a service identifier. For example, PE1 may advise PE2 that for a given service identifier X, VC label Y should be used. Similarly, PE2 may advise PE1 that for service identifier X, VC label Y′ should be used. This creates a first pseudo wire between PE1 and PE2 and the process is repeated for the remaining PEs in the network.

Once the VPLS instance for service identifier X is created, the first packets can be sent and the MAC learning process starts. Consider a situation in which a networked device ND1 112_1 sends a packet to CE1 102_1 that is addressed to ND2 112—2. ND1 and ND2 are each identified by a unique MAC address. PE1 receives the packet and learns from the source MAC address that ND1 can be reached on local port Z. It stores this information in the FIB for service identifier X. PE1 does not know the destination MAC address ND2, so it floods the packet to PE2 with a VC label for PE2 and to PE3 with a VC label for PE3. PE2 and PE3 thereby learn that ND1 is behind PE1 and stores this information in the FIB for service identifier X.

At this point, PE2 and PE3 do not know the location of ND2. They each flood packets to their local networked devices. ND2 thereby receives the packet from PE2. ND2 responds with a packet to ND1. PE2 receives the packet from ND2, learns its address and stores the information in the FIB for service identifier X. PE2 already knows that ND1 can be reached via PE1 and therefore only sends the packet to PE1 using an appropriate VC label. PE1 receives the packet and routes it to ND1. This process is repeated for new traffic. As a result, the MAC address tables are populated with network addressing information.

It can be appreciated that the MAC address tables associated with the prior art can grow to unwieldy sizes. Assuming that each customer has X MAC addresses that need to be learned and the switch is serving Y customers, the switch will need to learn X*Y MAC addresses. The flatter the customer network, the more MAC addresses the switch will have to support. Managing these MAC addresses is costly and complex. This problem is generally referred to as the MAC address scaling problem. One approach to addressing this problem is Hierarchical VPLS.

Hierarchical VPLS (H-VPLS) builds on the base VPLS solution and expands it to provide scaling and operational advantages. The scaling advantages of H-VPLS are obtained by introducing hierarchy, thereby eliminating the need for a full mesh of LSPs and PWs between all participating devices. Hierarchy is achieved by augmenting the base VPLS core mesh of PE to PE PWs (called hub PWs) with access PWs (called spoke PWs) to form a two-tier hierarchical VPLS model. It is difficult for providers to enforce Layer 3 router interface usage by their customers. H-VPLS is a method where tunneled paths are established from an edge switch to a switch closer to the core of the network. The switch in the core may be provisioned with greater memory capacity. This solution only pushes the problem from the edge to the core.

Thus, it would be desirable to provide a network architecture that solves the shortcomings associated with the prior art. In particular, it would be desirable to provide a VPLS network architecture that addresses the MAC address scaling problem.

### SUMMARY OF THE INVENTION

The invention includes a method of processing traffic in a Virtual Private LAN service. A MAC address from a packet is replaced with a realm specific Virtual Private Network address. The packet with the realm specific Virtual Private Network address is then processed.

The invention includes an apparatus for facilitating a Virtual Private LAN service. A customer edge switch is configured to receive a packet, map a source MAC address to a site identifier, assign a MAC address index value to the source MAC address, revise the source MAC address to include the site identifier and an index value, and convey the packet with the site identifier and the index value.

The invention also includes an apparatus for facilitating a Virtual Private LAN service. The apparatus includes a customer edge switch configured to receive a packet, identify a modified MAC address, replace the modified MAC address with a standard MAC address, and process the packet.

The invention provides a scalable VPLS architecture by replacing each MAC address with a realm specific VPN address. VPN specific information (as specified in RFC254) is encoded into the source MAC address field.

### BRIEF DESCRIPTION OF THE FIGURES

The invention is more fully appreciated in connection with the following detailed description taken in conjunction with the accompanying drawings, in which:

FIG. 1 illustrates a VPLS configured in accordance with an embodiment of the invention.

FIG. 2 illustrates source customer edge switch processing of a packet in accordance with an embodiment of the invention.

FIG. 3 illustrates a MAC to realm specific translation table utilized in accordance with an embodiment of the invention.

FIG. 4 illustrates destination provider edge switch processing of a packet in accordance with an embodiment of the invention.

FIG. 5 illustrates destination customer edge switch processing of a packet in accordance with an embodiment of the invention.

Like reference numerals refer to corresponding parts throughout the several views of the drawings.

### DETAILED DESCRIPTION OF THE INVENTION

The invention addresses the MAC address scaling problem by eliminating the need for provider edge switches (PEs) to record MAC address information. Further, the customer edge switches (CEs) need only record MAC address information relevant to a realm of interest. The technique operates as follows.

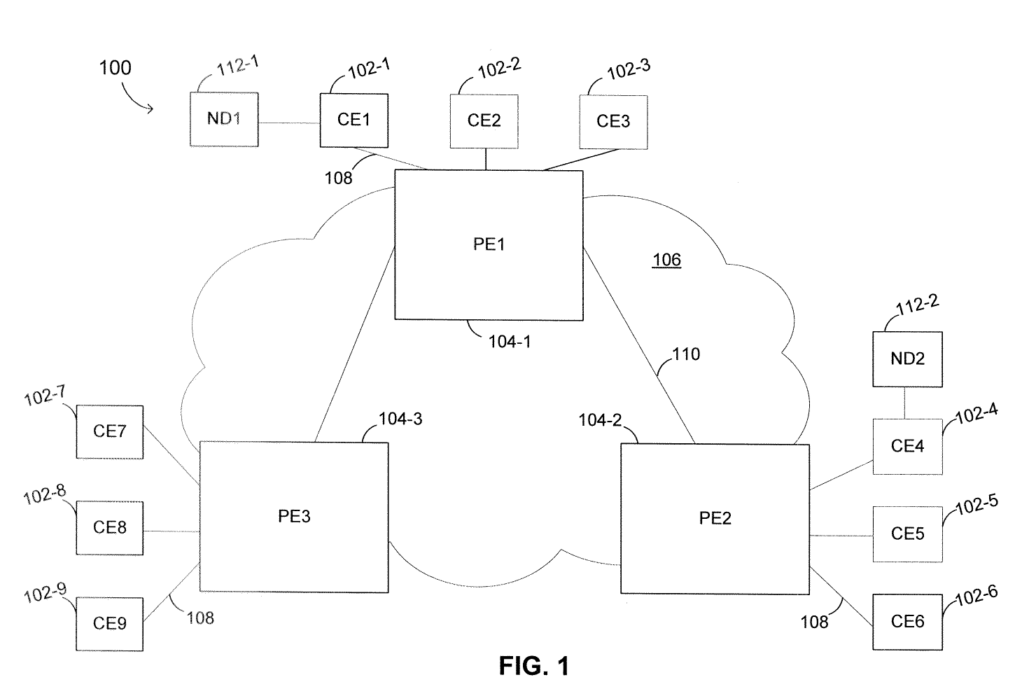

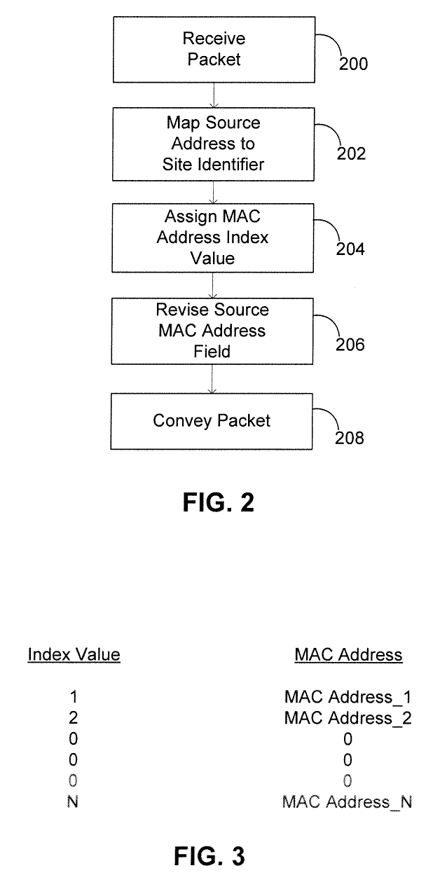

FIG. 2 illustrates processing associated with a customer edge switch that is the recipient of a source message. For example, the customer edge switch maybe switch CE1 of FIG. 1, which receives a message from network device ND1. The first processing operation of FIG. 2 is to receive a packet 200. The MAC source address for the received packet is then mapped to a site identifier 202. Every MAC frame includes a MAC control field, a destination MAC address, a source MAC address, a Logical Link Packet Data Unit (PDU), and a Cyclic Redundancy Check (CRC) field. The MAC source address is associated with a site identifier for a specific realm.

Next, a MAC address index is assigned to the MAC source address 204. FIG. 3 illustrates a MAC to realm specific translation table utilized in accordance with an embodiment of the invention. The table 300 includes a column of index values and a column of MAC addresses. In this example, the MAC source address for the received message may be assigned index value 1. Subsequent messages would be assigned incrementally higher index values.

At this point, a site identifier and an index value have been created for the received packet. The site identifier and the index value are substituted into the MAC source address field 206. In accordance with an embodiment of the invention, the revised source address field may also include authentication information, security information, and micro control information, as discussed below. The packet with the revised source address field is then conveyed to the provider edge switch 208.

A customer edge switch of the invention is implemented to include executable instructions to establish the processing of FIG. 3. In particular, the customer edge switch may be implemented to include executable instructions to receive a source packet, map a source address to a site identifier, assign a MAC address index value, revise the source MAC address field, and convey the packet with the revised source address field.

In accordance with the invention, the provider edge switch (e.g., PE1) routes the packet in accordance with its destination MAC address. The provider edge switch holds site identification information for the realm. In contrast to prior art provider edge switches, the provider edge switch of the invention does not record MAC address information.

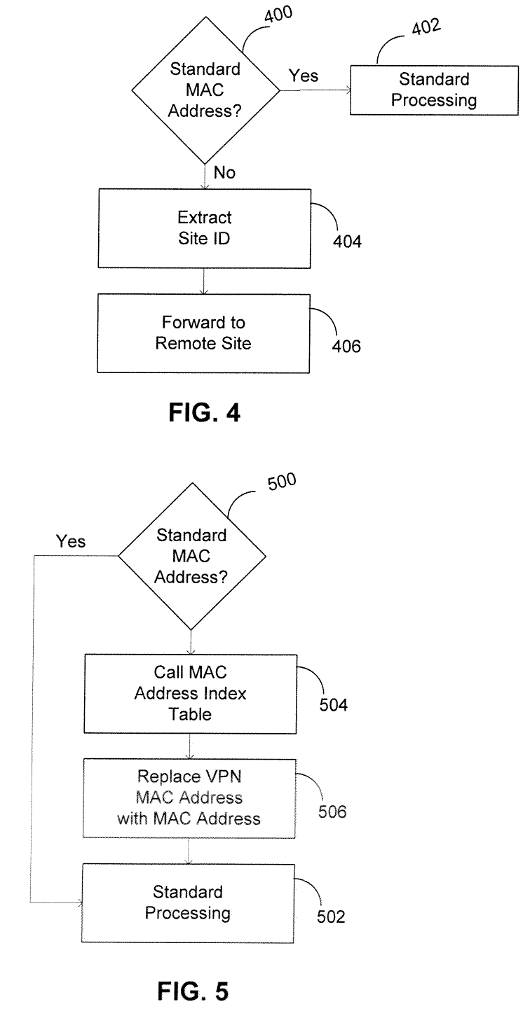

FIG. 4 illustrates processing associated with a provider edge switch (e.g., PE1) receiving a packet from the MPLS network 106. If a packet with a standard MAC source address is received 400, then standard processing is followed 402. If the MAC source address is modified in accordance with the invention, then the site identification is extracted 404 and the packet is forwarded to the specified site 406 (e.g., CE1).

A provider edge switch of the invention is implemented to include executable instructions to establish the processing of FIG. 4. In particular, the provider edge switch includes executable instructions to extract a site identifier and to forward a packet in accordance with the site identifier.

FIG. 5 illustrates processing associated with a customer edge switch receiving a packet. If the packet has a standard MAC address 500, then standard packet processing is invoked 502. If the MAC source address is modified in accordance with the invention, then the index value of the modified address is mapped to the MAC to realm specific translation table 504 (e.g., the table of FIG. 3). The MAC address is then substituted for the indexed value 506 and standard processing of the packet is performed 502.

A customer edge switch of the invention is implemented to include executable instructions to establish the processing of FIG. 5. In particular, the customer edge switch includes executable instructions to call a MAC address index, replace the index value with a standard MAC address, and then perform standard packet processing.

Essentially, the cross VPN MAC addresses are treated as being within a realm owned and managed by the service provider. The only possible problem posed by this would be a clash between the MAC addresses in the VPN realm and the customer realm. Given the size of the MAC address space, this is highly unlikely, but it needs to be guarded against. There are several solutions to the MAC address overlap problem. The simplest solution is for the service provider to use its own OUI for cross-VPN MAC addresses. Another solution is to run a simple protocol to detect clashes and to avoid using MAC addresses where they occur.

The invention solves the VPLS scaling problem. In addition, the invention is useful in authentication, security and micro control management. That is, the MAC address mapping policy and the realm specific MAC address encoding of the invention facilitate security and micro control management. The use of index values provides a measure of security since the index values are only meaningful to the entity controlling a realm. As discussed above, the revised source MAC address may include additional information directed toward authentication, security and micro control. The additional authentication, security and micro control information may be applied against rule bases implementing advanced functionality.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A method of processing traffic in a Virtual Private LAN service, comprising: replacing a MAC address from a packet with a realm specific Virtual Private Network address;
processing said packet with said realm specific Virtual Private Network address.

2. The method of claim 1 wherein replacing includes replacing a MAC address from a packet with a realm specific Virtual Private Network address comprising a site identifier and an index value.

3. The method of claim 2 wherein replacing includes replacing a MAC address from a packet with authentication information.

4. The method of claim 2 wherein replacing includes replacing a MAC address from a packet with security information.

5. The method of claim 2 wherein replacing includes replacing a MAC address from a packet with micro control information.

6. An apparatus for facilitating a Virtual Private LAN service, comprising:
a customer edge switch configured to:
receive a packet;
map a source MAC address to a site identifier;
assign a MAC address index value to said source MAC address;
revise said source MAC address to include said site identifier and an index value; and
convey said packet with said site identifier and said index value.

7. The apparatus of claim 6 wherein said customer edge switch is further configured to revise said source MAC address to include authentication information.

8. The apparatus of claim 6 wherein said customer edge switch is further configured to revise said source MAC address to include security information.

9. The apparatus of claim 6 wherein said customer edge switch is further configured to revise said source MAC address to include micro control information.

10. An apparatus for facilitating a Virtual Private LAN service, comprising:
a customer edge switch configured to:
receive a packet;
identify a modified MAC address;
replace said modified MAC address with a standard MAC address; and
process said packet.

11. The apparatus of claim 10 wherein said customer edge switch is configured to replace an index value with said standard MAC address.

12. The apparatus of claim 10 wherein said customer edge switch is configured to process authentication information in said modified MAC address.

13. The apparatus of claim 10 wherein said customer edge switch is configured to process security information in said modified MAC address.

14. The apparatus of claim 10 wherein said customer edge switch is configured to process micro control information in said modified MAC address.
